(19) United States
(12) Patent Application Publication
(10) Pub. No.: US 2005/0194374 A1
(43) Pub. Date: Sep. 8, 2005

(54) Heated ceramic substrate support with protective coating

(75) Inventors: Avgerinos V. Gelatos, Redwood City, CA (US); Olkan Cuvalci, Fremont, CA (US); Tong Zhang, Palo Alto, CA (US); Chen-An Chen, Milpitas, CA (US)

Correspondence Address: APPLIED MATERIALS, INC., Patent Department, M/S 2061, P.O. Box 450A, Santa Clara, CA, 95052, US

(73) Assignee: Applied Materials, Inc.

(21) Appl. No.: 10/792,054

(22) Filed: Mar. 2, 2004

(51) Int. Cl. H05B 3/74

(52) U.S. Cl. 219/444.1; 219/468.1

(57) ABSTRACT

A substrate support comprises a ceramic block, ceramic coating, resistance heater, and heater leads. The ceramic block comprises a first ceramic material and has a substrate receiving pocket sized to receive a substrate, a peripheral ledge extending about the substrate receiving pocket, and side surfaces. The ceramic coating comprises a second ceramic material and covers the substrate pocket and peripheral ledge of the ceramic block. In one version, the second ceramic material is composed of a silicon nitride compound. In another version, the second ceramic material is composed of an amorphous Si—H—N—O compound.

### BACKGROUND

The present invention relates to a substrate support for holding a substrate in a substrate processing chamber.

In the fabrication of electronic circuits and displays, semiconductor, dielectric, and electrically conducting materials are formed on a substrate, such as a silicon wafer or glass. The materials are typically formed by chemical vapor deposition (CVD), physical vapor deposition (PVD), ion implantation, oxidation and nitridation processes. Thereafter, the materials are etched to form features such as gates, vias, contact holes and interconnect lines. In a typical deposition or etching process, the substrate is exposed to a plasma to deposit or etch, respectively, a layer of material on the substrate. The plasma is can be formed by inductively or capacitively coupling energy to a process gas or by passing microwaves through the process gas.

The substrate fabrication processes are typically carried out in a substrate processing apparatus comprising one or more process chambers. A typical process chamber comprises a substrate support having a substrate receiving surface to hold the substrate in a process zone. The substrate support is exposed to a plasma formed in the chamber. The plasma can have elevated temperatures that arise from the interaction of energetic gaseous plasma species with one another and with the support. The substrate support can also be heated to maintain the substrate at elevated processing temperatures. Thus, the substrate support should be able to withstand exposure to the high process temperatures. For this reason, substrate supports often comprise ceramic materials, such as aluminum oxide (Al₂O₃) or aluminum nitride (AlN). Ceramic materials are able to withstand high temperatures without melting or otherwise degrading.

However, certain ceramic substrate supports are susceptible to corrosion by the particular compositions of gases used to generate the plasma in the chamber. For example, a ceramic substrate support of aluminum nitride corrodes in halogen gases to form undesirable gaseous byproducts, such as AlCl₃ or AlF₃, which subsequently condense on the walls and surfaces in the chamber. These deposited byproducts accumulate on the internal chamber surfaces over multiple process cycles in the course of processing a batch of substrates, until they get too thick, flake off and fall on the substrate or contaminate the chamber itself. The flaked off deposits reduce the yields of the circuits, displays or other devices manufactured on the substrate. Accumulated deposits also necessitate frequent cleaning of the chamber walls and resultant chamber downtime, thereby increasing equipment capitalization costs.

Corrosion of the ceramic substrate support is further exacerbated when the support is heated by an underlying heating system to maintain specified substrate temperatures. The substrate can be maintained at a high temperature to promote a localized heating environment that is desirable for the process being conducted. For example, particular substrate temperatures may be maintained to promote preferential decomposition of plasma species to deposit a layer on the substrate in a CVD process or to etch the substrate in an etching process. The elevated temperatures of the substrate support can exacerbate corrosion of the ceramic support because corrosion reactions are typically faster at higher temperatures. Also, corners or curved surfaces on the substrate support may be even more susceptible to corrosion.

Thus, there is a need for a substrate support that is capable of withstanding elevated temperatures. There is also a need for a substrate support that does not generate corrosion byproducts in erosive gas environments that could deposit on the enclosing walls of, and contaminate, the process chamber.

### SUMMARY

A substrate support comprises (i) a ceramic block having a substrate receiving pocket that is sized to receive a substrate therein, a peripheral ledge extending about the substrate pocket, and side surfaces; (ii) a ceramic coating comprising an amorphous Si—H—N—O compound, the coating covering the substrate pocket and peripheral ledge of the ceramic block; (iii) a resistance heater in the ceramic block; and (iv) heater leads extending out of the ceramic block to conduct electrical power to the resistance heater.

Also provided is a method of refurbishing a substrate support having a ceramic block and a residual ceramic coating. The refurbishment method comprises exposing the ceramic block to a fluorine-containing medium to remove the residual ceramic coating from the block to form a clean ceramic block, placing the clean ceramic block in a deposition chamber, and depositing a new ceramic coating on at least a portion of the clean ceramic block.

### DRAWINGS

These features, aspects, and advantages of the present invention will become better understood with regard to the following description, appended claims, and accompanying drawings which illustrate exemplary features of the invention:

FIG. 1a is a sectional side view of an embodiment of a substrate support according to the present invention;

FIG. 1b is a schematic sectional view of the support shown in FIG. 1a along section A-A;

FIG. 1c is another schematic sectional view of the support shown in FIG. 1a along section B-B;

FIG. 1d is yet another schematic sectional view of the support shown in FIG. 1a along section C-C;

FIG. 2a is a schematic sectional side view of another embodiment of the support showing an alternative coating coverage;

FIG. 2b is a schematic sectional side view of yet another embodiment of the support showing an alternative coating coverage; and

FIG. 3 is a schematic sectional side view of an embodiment of a substrate processing chamber comprising the substrate support.

### DESCRIPTION

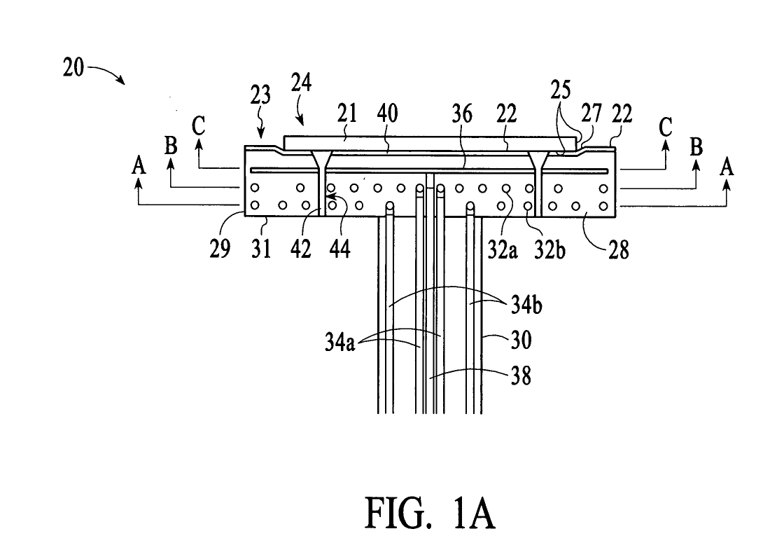

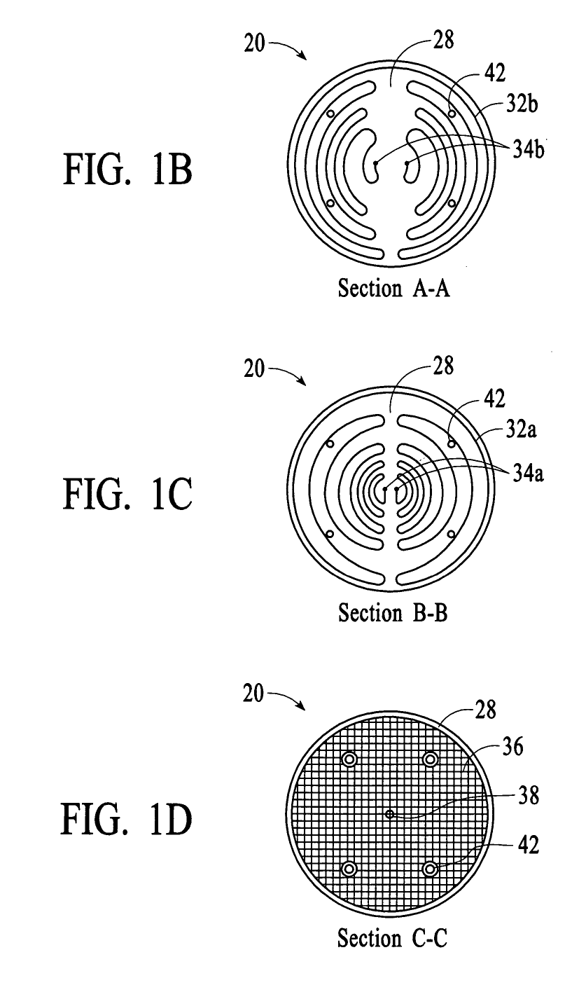

A substrate support is capable of holding a substrate in a substrate processing chamber. An embodiment of the substrate support 20 is schematically illustrated in FIGS. 1a-c. Generally, the substrate support 20 comprises a ceramic block 28 having a top surface 22 that is exposed to the plasma in the chamber. The ceramic block 28 is a monolith comprising a unitary structure composed of a dielectric or semiconducting ceramic material. The top surface 22 of the ceramic block 28 comprises a substrate receiving pocket 24 into which a substrate 21 is received for processing. The pocket 24 is planar and recessed relative to other portions of the top surface 22 of the ceramic block 28. The pocket 24 is sized to receive and accurately position the substrate 21 on the receiving surface 22. The ceramic block 28 also comprises a peripheral ledge 23 extending about the substrate receiving pocket 24. The peripheral ledge 23 serves to hold the substrate in place, and also protect the bottom and side surfaces 25 of the substrate from unwanted deposition. In one version, the peripheral ledge 23 has a height of about 6% to about 8% of the height of a typical substrate 21; however, other suitable heights may also be used. The transition 27 between the pocket 24 and the peripheral ledge 23 comprises a chamfered corner. The arcuate corner further reduces the erosion susceptibility of the dielectric material in corrosive gas environments.

Corrosive gases present in a substrate processing chamber, such as a halogen based plasma, can corrode the ceramic block 28. In general, the exposed surfaces of the entire ceramic block 28, which include the top surface 22 and a side surface 29, are subject to corrosion. In particular, the transition region 27 between the substrate pocket 24 and the peripheral ledge 23 is especially susceptible to corrosion because it has a non-planar geometry. Corrosion occurs because energized gas used to process the substrate or clean the chamber can etch the ceramic block 28. For example, an energized halogen gas, such as a chlorine-containing gas used to clean certain types of chambers is capable of etching many ceramics, including aluminum nitride. Etching byproducts can be generated as deposits on chamber walls or particles within the chamber. These deposits can eventually peel and flake off the walls to generate particles that can fall into a substrate 21 and reduce the yield of devices or circuits being manufactured on the substrate 21.

To reduce or eliminate this problem, the ceramic block 28 of the substrate support 20 further comprises a ceramic coating 40 on at least the plasma exposed portions of the top surface 22 of the ceramic block 28. The protective ceramic coating 40 is made of a different ceramic material than the ceramic block 28. Thus, if the ceramic block 28 is composed of a first ceramic material, the ceramic coating 40 is composed of a second ceramic material. In one version, as illustrated in FIG. 1a, the ceramic coating 40 extends substantially across the entire top surface 22, including the recessed substrate pocket 24, peripheral ledge 23, and transition region 27. This version is useful when only the top surface 22 is exposed to a corrosive gas, for example, when there are rings or liners that effectively separate the process zone from other surfaces of the substrate support 20, such as side surfaces 29 and a bottom surface 31. In this version, it is not necessary for the coating coverage to include portions of the ceramic block 28 other than the substrate receiving surface 22.

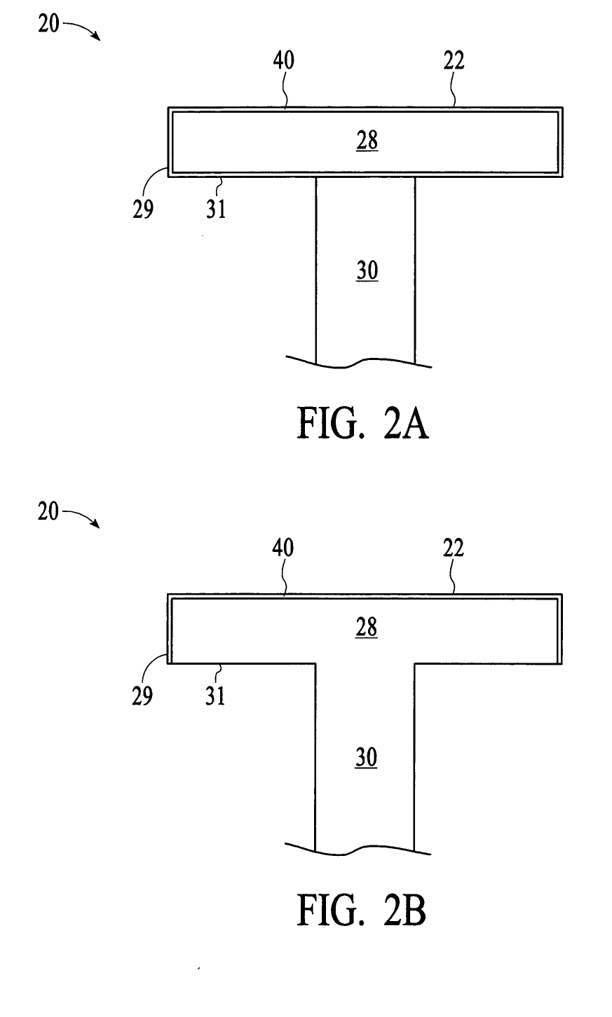

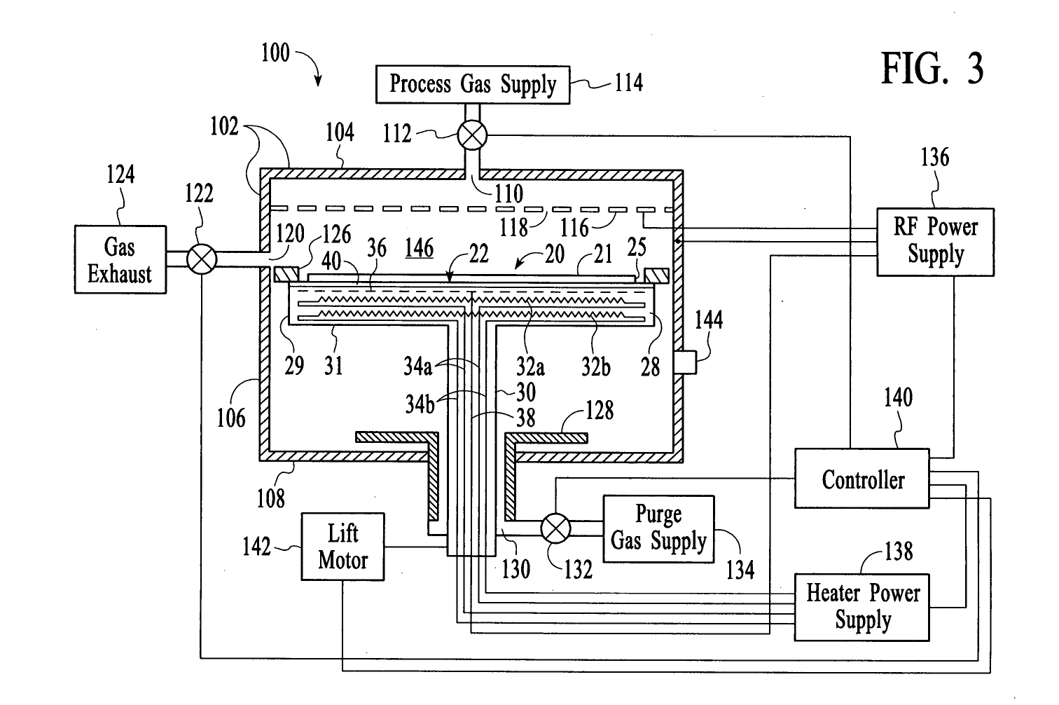

In other versions, illustrated in FIGS. 2a-b, the coating 40 covers the entire ceramic block 28 or selective portions of the block 28. For example, in FIG. 2a, the coating coverage includes the entire external surfaces of the ceramic block 28. This version is useful when the entire substrate support 20 is subjected to corrosive gases, for example, when the substrate support 20 is positioned in a chamber such that the side 29 and bottom surfaces 31 of the ceramic block 28 are exposed to the process zone. The coating covers all exposed areas of the ceramic block 28.

In FIG. 2b, the coating coverage includes the top surface 22 and the sides 29 of the ceramic block. This version is useful when the top surface 22 and the sides 29 of the ceramic block are exposed to corrosive gases, but other surfaces of the ceramic block are not. For example, this could occur if the bottom surface 31 of the ceramic block is covered by another surface within the chamber, for instance a support member below the substrate support 20, or a surface of an enclosing wall of the chamber.

The portions of the block 28 covered by the coating 40 are selected depending on the application of the substrate support 20 and the method used to manufacture the substrate support 20. Thus, while particular exemplary embodiments of coating coverage are illustrated herein, other coating coverage embodiments are possible for different applications as would be evident to one of ordinary skill in the art, so the illustrative embodiments should not be used to limit the scope of the invention.

The coating 40 is composed of a material that is selected so that even though the material is eroded by the corrosive process gas, the erosion byproducts of the coating 40 are volatile products that do not condense on the chamber surfaces to form deposits on the chamber walls or gas phase nucleated particles within the chamber. The coating 40 essentially transforms from the solid phase to a volatile gas phase, which is then exhausted by the vacuum pumps of the chamber. This solves the problem of contaminating deposits and particles because the coating 40 does not contribute condensable species that form deposits and particles in the chamber. For example, when the coating 40 comprises silicon nitride, the byproducts of silicon nitride eroded by a corrosive energized chlorine gas atmosphere are exhausted through a gas outlet of the chamber and do not remain as deposits or particles in the chamber. Thus, the coating performs as a sacrificial layer that protects the underlying ceramic material from the erosive gaseous environment.

In one version, the ceramic block 28 comprises a ceramic material with a volume electrical resistivity of greater than about 10¹⁴ ohm·cm at 20° C.. The dielectric material is also selected to have a good thermal conductivity to facilitate heat transfer between the support and the substrate. The thermal conductivity of the ceramic material should be such that the rate of heat transferred through the block to the substrate achieves a desired level. For example, the ceramic can comprise a thermal conductivity of from about 140 W/m·K to about 180 W/m·K. In one version, the block 28 comprises a ceramic such as aluminum nitride. The block 28 can comprise, for example, at least about 99.9% aluminum nitride by weight.

In one version, a suitable ceramic coating 40 comprises a silicon nitride compound. The coating 40 can comprise, for example, at least about 90% silicon nitride by weight. The coating 40 protects the underlying ceramic block 28 from being eroded by corrosive gases and plasma present in the chamber. The coating is composed of a second material that is a different ceramic material than the ceramic material of the underlying ceramic block 28. For example, when the first ceramic material is AlN, and the corrosive process gas includes Cl₂, the second material may comprise Si₃N₄.

In another version, the coating 40 comprises a ceramic material comprising at least about 50% of a silicon nitride compound by weight. One advantage to this version is that the response of the coating 40 can be tailored to protect the block from different corrosive gases. For example, if the corrosive gas comprises NF₃, ClF₃ and HCl, then the coating 40 could have a composition of about 75% by weight of the silicon nitride compound, with the remaining 25% of silicon dioxide. This would provide suitable corrosion response of the coating 40 to Cl₂, NF₃, ClF₃, and C₂F₆.

In yet another version, the coating 40 comprises an amorphous ceramic compound. In one embodiment of this version, the amorphous ceramic compound comprises silicon, nitrogen, hydrogen, and oxygen. The advantage of an amorphous Si—N—H—O compound is that the composition of the coating 40 can be selected to provide suitable protection for the block 28 against various corrosive gases. Another advantage of an amorphous Si—N—H—O compound is that that composition of the coating 40 can be selected to provide suitable adherence of the coating 40 to various ceramic block materials. In this embodiment, the silicon content of the amorphous compound can be from about 30% to about 50% by weight. The nitrogen content can be from about 20% to about 40% by weight. The hydrogen content can be from about 2% to about 30% by weight. The oxygen content can be from about 1% to about 5% by weight. In another embodiment of this version, the amorphous ceramic compound comprises a silicon nitride compound.

The ceramic coating 40 comprising a silicon nitride compound or an amorphous Si—H—N—O compound also provides a good thermal expansion coefficient match with a ceramic block 28 comprising aluminum nitride. A suitable silicon nitride or amorphous Si—H—N—O compound can have a thermal expansion coefficient of, for example, from about 3.1×10⁻⁶/° C. to about 3.4×10⁻⁶/° C. at room temperature. By comparison, the aluminum nitride material has a thermal expansion coefficient of, for example, about 4.4×10⁻⁶/° C. to about 4.7×10⁻⁶/° C. at room temperature. An excessively large mismatch in thermal expansion coefficients is undesirable because the substrate support 20 potentially goes through temperature cycles that cause stresses in the coating 40 as the support 20 expands and contracts. These stresses can eventually cause the coating 40 to crack and peel away from the ceramic block 28, which it is desirable to avoid.

The thickness of the coating 40 is selected to withstand multiple process cycles while providing good thermal performance. The thickness varies depending on the choice of the ceramic block material and the manufacturing methods used to produce the block 28 and the coating 40. The corrosion response provided by the coating 40 will eventually deplete the coating 40. The thickness can be chosen to provide a coating with a specified useful lifetime. For example, the coating thickness can be chosen based on the rate at which the support 20 is subjected to processes conducted in a processing chamber. The thickness of the coating 40 can also be chosen based on facilitating heat transfer between the support 20 and the substrate 21. For example, the thickness of the coating 40 can be chosen to provide a specified thermal resistance for the coating 40 based on the thermal resistivity of the silicon-nitride-containing compound. In one version, a suitable thickness of the coating 40 is from about 0.1 micron to about 15 microns.

The ceramic coating 40 can be applied onto the ceramic block 28 using various methods. For example, the method of forming the coating 40 can comprise physical and chemical vapor deposition methods, a plasma spraying method, twin wire arc spraying method, or other thermal spraying method. One exemplary coating process uses a chemical vapor deposition to deposit the coating 40 onto the block 28. In the chemical vapor deposition method the portion of the block 28 to be coated is exposed in a process chamber to a deposition gas and heated to deposit a coating 40 on the exposed portion of the block 28. To deposit a silicon nitride compound, the deposition gas desirably comprises silicon-containing and nitrogen-containing species. For example, the deposition gas can comprise a silicon-containing gas comprising, for example, silane. The deposition gas can also comprise a nitrogen-containing gas, comprising at least one of ammonia, nitrogen and N₂H₄. An inert gas such as argon can also be provided. For example, in one method of fabrication, deposition gas comprising SiH₄ in a volumetric flow rate of about 5 sccm to about 50 sccm and NH₃ in a volumetric flow rate of about 250 sccm to about 10,000 sccm is introduced into the process chamber. The temperature of the block 28 is desirably maintained at a temperature of about 600° C. to about 800° C. during the deposition process, and a pressure in the chamber is maintained at about 90 Torr to about 300 Torr.

The process of fabricating the block 28 having the coating 40 may optionally include an annealing step to finely tune properties of the coating 40. In one version, a suitable temperature at which to anneal the block 28 and coating 40 is at about 200° C. to about 800° C., and such as about 400° C., for a duration of about 2 hours to about 24 hours. The manufacturing process conditions, including temperature, gas compositions, and energizing levels used during fabrication or annealing of the coating 40, is monitored and controlled to avoid flaking of the coating 40. In one method, the annealing step is alternated with the chemical vapor deposition to anneal each fine layer of deposited material. This reduces stresses in the deposited coating and allows deposition of a thicker layer of the sacrificial ceramic coating. The annealing step and chemical vapor deposition step may be alternated a plurality of times. In the chemical vapor deposition process, the deposition gas can also be energized by coupling, for example, RF energy or microwave energy to the deposition gas to form energized silicon and nitrogen-containing species that interact to form the silicon nitride compound coating 40 on the block 28.

The substrate support 20 also comprises a post 30 to hold and position the ceramic block 28 within the processing chamber. The post 30 also provides a convenient way for electrical leads to reach the ceramic block 28 from outside of the chamber. The post 30 comprises a hollow cylinder and may comprise a ceramic or metal. The post 30 can be manufactured using a variety of methods, including casting, machining, and forging. The post 30 can be attached to the ceramic block 28 by mechanical fasteners such as screws and bolts, or by a fabrication process such as sintering, hot pressing, and other methods.

The substrate support 20 further comprises a resistance heater 32 to control heat transfer between the substrate 21 and the support 20. The resistance heater 32 comprises an electrical resistance that generates heat upon application of a voltage across the resistance. The support 20 also comprises heater leads 34 extending out of the ceramic block 28 to conduct electrical power to the resistance heater 32. The amount of heat generated is related to the power applied to the resistance heater 32. Controlling this power allows fine control of the heat generated by the resistance heater 32. Controlling the heat generation of the resistance heater 32 allows control of the substrate support temperature and thus control of the heat transfer between the substrate 21 and the support 20. Ultimately, the temperature of the substrate 21 can be controlled by the power applied to the resistance heater 32. The resistance heater 32 is desirably capable of maintaining the substrate 21 at temperatures in a range of about 200° C. to about 800° C..

In one version, the resistance heater 32 comprises a cylindrical metal wire coiled concentrically to form a spiral from the center to the edge of the block 28. For example, the resistance heater 32 can be a molybdenum wire. The gauge of the wire is chosen depending upon, among other factors, the amount of heat generated per cross-sectional area of the wire for the chosen material and the desired electrical resistance of the resistance heater 32. The resistance heater 32 is desirably completely enclosed by the block 28. The resistance heater 32 can also comprise other physical embodiments, for example alternate materials such as ceramics, or other geometries, such as a wire mesh, multiple coils of wire, or ribbons of material. The heater leads 34 conducting electrical power to the resistance heater 32 can comprise conductors such as molybdenum and nickel.

The resistance heater 32 can also comprise more than one independently controllable resistive element. The independently controllable resistive elements provide independent heating in different parts of the support 20. For example, the resistance heater 32 can comprise two independently controllable resistive elements, each having an electrical resistance of between about 2.5 ohms to about 5 ohms, that provide separate heating of two spatially concentric zones on the top surface 22, an inner zone and an outer zone. An inner resistive element 32a can be concentrated beneath the inner zone, and an outer resistive element 32b concentrated beneath the outer zone, and the elements are provided with separate heater leads 34a, 34b, respectively, extending down through the block 28 to an external power supply. Depending upon the desired temperature control, the inner and outer resistive elements 32a, 32b can receive different power levels from the heater power supply, to heat the inner and outer zones to different temperatures. This provides the ability to compensate for radial temperature variations in the substrate 21, which can arise from the geometry and heat transfer characteristics of the support 20 and the substrate processing chamber.

In another version, there is only one resistive element, having an electrical resistance of about 2.5 ohms to about 5 ohms, to control heat delivered to the entire support. This is advantageous when the substrate process being conducted does not require radial temperature control. In yet another version, there are three separate, independently controllable zones having separately controllable resistive elements: inner, outer, and middle zones. Again in this version, each resistive element beneath each zone has separate heater leads that allow independent control by the heater power supply. This version is advantageous for substrate processes require a high degree of radial temperature control. The substrate support 20 may optionally comprise a plurality of thermocouples to monitor the temperature at various regions of the support 20 and provide a basis for adjusting the power delivered to the independently heated zones.

The substrate support 20 may also optionally comprise a gas energizer electrode 36 that functions as a part of a gas energizer, for example by coupling RF energy to a gas in the process chamber. In one version, the electrode 36 comprises a metallic mesh integrated into the ceramic block 28. The electrode 36 can comprise a metal such as molybdenum. The electrode 36 is connected to an electrode lead 38 that passes through the post. The electrode lead 38 can electrically connect the electrode 36 to another portion of the chamber or can ground the electrode 36. The electrode lead 38 can also optionally connect the electrode 36 to an RF or microwave power supply 136 to bias and provide an RF or microwave signal to the electrode 36. In one version, the electrode lead 38 comprises a nickel-based material. The physical design of the electrode 36 and the electrode lead 38 are conducted according to principles of electromagnetic wave propagation at the relevant frequencies, for instance RF or microwave frequencies.

The substrate support 20 also comprises holes 44 for lift pins 42, as illustrated in FIG. 1a-c, to lift the substrate 21 from the top surface 22. The lift pins 42 are positioned at several locations within holes 44 in the ceramic block 28. For example, in one version, there are four pins 42 positioned equidistant to the center of the support 20, at 90° angles from each other. The pins 42 move perpendicular to the plane of the substrate pocket 24. The pins 42 may be activated by a mechanical system that is part of the chamber in which the substrate support 20 is located. Such a mechanical system can activate the lift pins 42 from the side of the block 28 opposite to the top surface 22.

The substrate support 20 can be used in substrate processing chambers that deposit Ti-based layers on substrates 21. One type of chamber to deposit Ti-based layers is a chemical vapor deposition (CVD) chamber such as the one illustrated in FIG. 3. The chamber 100 can be a stand-alone chamber or part of a larger processing system that includes multiple chambers. The exemplary substrate processing chamber has enclosing walls 102, including a top wall 104, side walls 106, and a bottom wall 108. The enclosing walls 102 enclose a process zone 146 in which a substrate 21 is processed. A substrate support 20, such as that shown in FIG. 1A, holds the substrate 21 in the process zone 146. The support's post 30 is attached to a lift motor 142 that allows the support 20 to move up and down within the chamber 100. In a low position, the support 20 can align with a port 144 through which the substrate 21 is introduced to the chamber 100 and loaded onto the support 20. The substrate 21 can be loaded into the chamber 100 by a robot arm (not shown). A wafer lift ring 128 comprising a ring concentric to the support post 30 may also be present. The wafer lift ring 128 rises independently from the post 30, and rises from below the block 28 into contact with the lift pins 42. The chamber 100 may also comprise an edge ring 126 to promote separation of the portion of the chamber below the substrate support 20 from the process zone 146.

A process gas is introduced into the chamber 100 via a process gas inlet 110. The process gas passes through a showerhead-style gas distributor 116 and then into the process zone 146. The gas inlet 110 is fed from a process gas valve 112 and a process gas supply 114. The showerhead 116 uniformly distributes the process gas to the process zone 146. The showerhead 116 can be a plate with a plurality of holes 118 through which the process gas passes. Alternatively, the showerhead 116 can be integral to the top wall 104. The gas distributor can also be of a style different from a showerhead. A purge gas can also be introduced into the chamber from a purge gas inlet 130 fed by a purge gas valve 132 and a purge gas supply 134. Gas is exhausted from the chamber 100 through a gas outlet 120. The gas outlet 120 feeds through a exhaust valve 122 into a gas exhaust 124.

In the version shown in FIG. 4, the showerhead 116 also serves as an electrode of a gas energizer. The showerhead is connected to the RF or microwave power supply 136. The showerhead delivers RF or microwave radiation to the process gas to energize the gas. The enclosing walls 102 and substrate support 20 can be grounded relative to the showerhead electrode 116. The process chamber 100 also comprises a heater power supply 138 to deliver power to the resistance heater 32. In one version, the heater power supply 138 is capable of delivering at least about 1000 Watts of power to the resistance heater 32.

A controller 140 may be used to operate the substrate processing chamber 100, including controlling the RF power supply 136, process gas valve 112, exhaust gas valve 122, purge gas valve 132, heater power supply 138, lift motor 142, and other components requiring precise control. A suitable controller 140 comprises a computer (not shown) having a central processing unit (CPU), such as a Pentium Processor commercially available from Intel Corporation, Santa Clara, Calif., that is coupled to a memory, peripheral computer components, and program code to provide instructions to the components of the substrate processing chamber 100. The controller 140 may further comprise a plurality of interface cards (also not shown) including, for example, analog and digital input and output boards, interface boards, and motor controller boards. The interface between a human operator and the controller 140 can be, for example, via a display and a light pen.

One method to deposit a Ti-based layer, for instance a TiN layer, is to react TiCl₄ and NH₃ in a plasma-enhanced CVD chamber 100. These gases are introduced into the process zone 146 from the process gas inlet 110 through the showerhead 116. Optionally, there may be separate inlets or process gas valves for each process gas. Additionally, the process gas may comprise carrier gases such as He, H₂, or Ar. An inert purge gas can be flowed between the edge ring 126 and the enclosing walls 102 to prevent process gases from entering into the lower portion of the chamber. The purge gas flow can also be used to finely tune the characteristics of the process zone 146 near the edges of the substrate support 20.

During the deposition of a Ti-based layer on the substrate 21 in the chamber 100, Ti-based and other chemicals also deposit on surfaces of the chamber 100, such as the enclosing walls 102, edge ring 126, process gas inlet 110, and gas outlet 120. If this extraneous deposition on surfaces other than the substrate 21 is allowed to continue unchecked, the deposits will build until they become unstable, at which point they may begin to flake off the surface on which they've grown. The chamber 100 must be periodically cleaned to remove these extraneous deposits. One method to clean the chamber 100 uses a plasma formed from chlorine gas. Chlorine gas is introduced into the chamber 100 by the process gas inlet 110 and energized using the gas energizer 116. The energized chlorine gas etches away the Ti-based deposits and cleans the chamber 100. Unfortunately, the chlorine gas also corrodes the substrate support 20. The coating 40 according to the present invention, however, provides corrosion response for the support 20 against the energized chlorine gas used to clean Ti-based deposits from chamber surfaces.

The substrate support 20 according to the present invention can also be refurbished to provide an extended useful lifetime. The coating 40 is consumed by the corrosion response it provides to the support 20. After substantial use, the coating 40 can be refurbished to restore portions of the coating 40 that have been depleted.

The refurbishment process comprises first exposing the ceramic block 28 to a fluorine-containing cleaning medium to remove the residual ceramic coating 40 from the block 28. In one version, the fluorine-containing cleaning medium comprises an acidic solution. For example, a suitable acidic solution could comprise one or more of HF, HNO₃, NF₄H, H₂O₂, and H₂O. In an exemplary process to remove the residual ceramic coating 40 using an acidic solution, the ceramic block 28 is exposed to a 20% HF solution by weight, for a period of about 10 minutes to about 40 minutes. The ceramic block 28 can be rinsed with a water solution following exposure to the acidic cleaning solution.

In another version, the cleaning medium comprises an energized fluorine-containing gas. For example, the ceramic block 28 can be placed in a processing chamber adapted to implement an etching process using an energized fluorine-containing gas. In one version, the process gas to be energized could comprise NF₃, CF₄, C₂F₆ or ClF₃. In an exemplary version of cleaning the residual coating 40 using an energized fluorine-containing gas, the ceramic block 28 is placed in the processing chamber, NF₃ is introduced into the chamber and energized, and the etching process is conducted at about 200° C. to about 500° C. for about 0.5 hours to about 3.0 hours.

The refurbishment method further comprises placing the cleaned ceramic block 28 in a deposition chamber and depositing the ceramic coating 40 on at least a portion of the cleaned ceramic block 28. This deposition can use the same methods and apparatuses discussed above in regards to manufacturing the coating 40 on the ceramic block 28. For example, the deposition can comprise heating the cleaned ceramic block 28 and exposing the heated ceramic block 28 to a process gas comprising silicon and nitrogen species. In one version, the clean ceramic block 28 is heated to a temperature of about 600° C. to about 800° C., and the process gas comprises silane, ammonia, and nitrogen. The refurbishment process may further comprise annealing the block 28, as discussed above in regards to the method of manufacturing the coating 40 on the block 28. For example, the annealing step may comprise heating the block 28 to a temperature of about 200° C. to about 800° C. for a duration of about 2 hours to about 24 hours.

Although the present invention has been described in considerable detail with regard to the preferred versions thereof, other versions are possible. For example, the ceramic material of the block 28 can comprise ceramic materials other than those mentioned. Additionally, relative terms such as bottom, top, up, and down are in some instances interchangeable and have been used merely to describe embodiments of the invention. Therefore, the appended claims should not be limited to the preferred versions and relative terms contained herein.

1. A substrate support for a substrate processing chamber the substrate support comprising:
(a) a ceramic block having a substrate receiving pocket that is sized to receive a substrate therein, a peripheral ledge extending about the substrate receiving pocket, and side surfaces:
(b) a ceramic coating covering the substrate pocket and peripheral ledge of the ceramic block, the ceramic coating comprising an amorphous Si—H—N—O compound;
(c) a resistance heater in the ceramic block; and
(d) heater leads extending out of the ceramic block to conduct electrical power to the resistance heater.

2. A support according to claim 1 wherein the amorphous Si—H—N—O compound comprises a silicon content of about 30 wt % to about 50 wt % and a nitrogen content of about 20 wt % to about 40 wt %.

3. A support according to claim 1 wherein the amorphous Si—H—N—O compound comprises a hydrogen content of about 2 wt % to about 30 wt % and an oxygen content of about 1 wt % to about 5 wt %.

4. A support according to claim 1 wherein the ceramic coating comprise a thickness of about 0.1 microns to about 15 microns.

5. A support according to claim 1 wherein the ceramic block is composed of aluminum nitride.

6. A support according to claim 1 comprises an electrode in the ceramic block and an electrode lead extending out of the ceramic block.

7. A support according to claim 1 wherein the resistance heater comprises an electrical conductor having an electrical resistance of about 2.5 ohms to about 5 ohms.

8. A support according to claim 1 wherein the resistance heater comprises a plurality of independently controllable resistive heating elements.

9. A support according to claim 6 comprising a post extending downwardly from the center of the ceramic block, and wherein the heater leads and the electrode lead extend at least partially through the post.

10. A substrate processing apparatus comprising the substrate support of claim 1, the apparatus comprising;
(1) a process chamber comprising enclosing walls, the substrate support of claim 1, a gas distributor, a gas exhaust, and a gas energizer;
(2) a heater power supply to provide a power at a power level of at least about 1000 watts, to the resistance heater; and
(3) a controller comprising program code to provide instructions to the heater power supply to supply the power having the power level to the resistance heater,
whereby the controller controls the power delivered to the resistance heater by the heater power supply.

11. A substrate support for a substrate processing chamber, the substrate support comprising:
(a) a ceramic block having a substrate receiving pocket that is sized to receive a substrate therein, a peripheral ledge extending about the substrate receiving pocket, and side surfaces;
(b) a silicon nitride compound coating covering the substrate pocket and peripheral ledge of the block;
(c) a resistance heater In the block; and
(d) heater leads extending out of the block to conduct electrical power to the resistance heater.

12. A support according to claim 11 wherein the silicon nitride compound coating is amorphous.

13. A support according to claim 11, wherein the silicon nitride compound coating comprises a silicon content of from about 30 wt % to about 50 wt % and a nitrogen content of from about 20 wt % to about 40 wt %.

14. A support according to claim 11 wherein the silicon nitride compound coating comprises hydrogen and oxygen.

15. A support according to claim 14 wherein the silicon nitride compound coating comprises a hydrogen content of about 2 wt % to about 30 wt % and an oxygen of about 1 wt % to about 5 wt %.

16. A support according to claim 11 comprising an electrode in the ceramic block and an electrode lead extending out of the ceramic block

17. A support according to claim 11 wherein the resistance heater comprises a plurality of independently controllable resistive heating elements.

18. A substrate support for a substrate processing chamber, the substrate support comprising:
(a) a block comprising a first ceramic, the block having a substrate receiving pocket that is sized to receive a substrate therein, a peripheral ledge extending about the substrate receiving pocket, and side surfaces;
(b) a coating comprising a second ceramic that is a different ceramic than the first ceramic, the coating covering the substrate pocket and peripheral ledge of the block, and the second ceramic comprising an amorphous Si—H—N—O compound or silicon nitride compound;
(c) a resistance heater in the block;
(d) a gas energizer electrode in the block; and
(e) heater and electrode leads extending out of the block to conduct power to the resistance heater and gas energizer electrode, respectively.

19. A support according to claim 18 wherein the second ceramic consists essentially of a silicon nitride compound.

20. A support according to claim 19 wherein the silicon nitride compound is amorphous.

21. A support according to claim 19 wherein the silicon nitride compound comprises a silicon content of from about 30 wt % to about 50 wt % and an nitrogen content of from about 20 wt % to about 40 wt %.

22. A support according to claim 18 wherein the second ceramic consists essentially of an amorphous Si—H—N—O compound.

23. A support according to claim 22 wherein the amorphous Si—H—N—O compound comprises a silicon content of about 2 wt % to about 30 wt % and an oxygen content of about 1 wt % to about 5 wt %.

24. A support according to claim 18 wherein the resistance heater comprises a plurality of independently controllable resistive heating elements.

25. A method of refurbishing a substrate support comprising a ceramic block having a residual ceramic coating, the method comprising:
(a) exposing the substrate support to a fluorine-containing cleaning medium to remove the residual ceramic coating from the ceramic block to form a clean ceramic block;
(b) placing the clean ceramic block in a deposition chamber; and
(c) depositing a new ceramic coating on at least a portion of the clean ceramic block.

26. A method according to claim 22 wherein the fluorine-containing cleaning medium comprises an acidic solution.

27. A method according to claim 22 wherein the fluorine-containing cleaning medium comprises an energized fluorine-containing gas.

28. A method according to claim 22 wherein (c) comprises heating the clean ceramic block and exposing the heated ceramic block to a process gas comprising silicon and nitrogen species.

29. A method according to claim 22 comprising:
(d) annealing the new ceramic coating.

30. A method according to claim 29 comprising alternating (c) and (d) a plurality of times.

31. A method according to claim 28 wherein the process gas comprises silane, ammonia, and nitrogen.
